(19) United States
(12) Patent Application Publication
(10) Pub. No.: US 2004/0184065 A1
(43) Pub. Date: Sep. 23, 2004

(54) Method and apparatus for preventing reproduction of copy-inhibited documents

(76) Inventors: Haike Guan, Kanagawa-ken (JP); Yasushi Abe, Kanagawa-ken (JP); Masaaki Ishikawa, Tokyo (JP); Takashi Saitoh, Kanagawa-ken (JP)

Correspondence Address: DICKSTEIN SHAPIRO MORIN & OSHINSKY LLP, 2101 L STREET NW, WASHINGTON, DC, 20037-1526, US

(21) Appl. No.: 10/738,139

(22) Filed: Dec. 18, 2003

(30) Foreign Application Priority Data
Dec. 19, 2002 (JP) 2002-367855

(51) Int. Cl. G06F 3/12; G06F 15/00; G06K 9/68; G06F 11/30

(52) U.S. Cl. 358/1.14; 382/218; 358/1.15; 710/19

(57) ABSTRACT

An image processing apparatus includes an image obtaining device that obtains original image data, an image output device that outputs the obtained image data, an initial parameter setting device that sets initial parameters with respect to a detection of a copy-inhibited document, a background dot pattern extracting device that extracts a background dot pattern embedded in a background image of an original image, a copy-inhibited background dot pattern storing device that stores a copy-inhibited background dot pattern, a pattern match detecting device that detects a match between the background dot pattern and the copy-inhibited background dot pattern, an image output inhibiting device that inhibits an output of the image data, an image-output-inhibition notifying device that notifies an inhibition of the output of the image data, a cancellation receiving device that receives cancellation of the inhibition, and a canceling device that cancels the inhibition of the output of the image data.

### CROSS-REFERENCE TO RELATED APPLICATIONS

The present application claims priority to Japanese Patent Application No. 2002-367855 filed in the Japanese Patent Office on Dec. 19, 2002, the disclosure of which is incorporated herein by reference.

### FIELD OF THE INVENTION

The present invention relates to a method, program, and apparatus for detecting a copy-inhibited document, prohibiting reproduction thereof, and securely controlling the information of a copy-inhibited document. The present invention also relates to a medium storing the above-described program for detecting a copy-inhibited document, prohibiting reproduction thereof, and securely controlling the information of a copy-inhibited document.

### BACKGROUND OF THE INVENTION

With recent improvements in image processing and image forming technologies, it has become possible that a digital color copying machine can reproduce a monetary document with high fidelity such that the reproduced image is hardly distinguished from the original. Monetary documents include, for example, bills, securities, and the like, and cannot normally be copied since unauthorized monetary document reproduction is illegal. Therefore, the digital color copying machine requires a feature that prevents high fidelity reproduction of such a monetary document. With this feature, the reproduction of such a monetary document may be prevented entirely or may be performed such that the resulting copy is unreadable, for example.

In offices, for example, even ordinary documents other than monetary documents, such as, bills and securities, are often inhibited from being copied for a secrecy purpose. Therefore, the digital color copying machine further requires a feature that prevents the reproduction of such a confidential document.

Under these circumstances, various techniques have been used with the above-described digital color copying machine in an attempt to restrict unauthorized image reproduction of these monetary documents and confidential documents.

Published Japanese patent application No. 6-125459 describes a technique for recognizing special documents, such as, bills, securities, and the like by comparing input image data with a previously stored specific mark using pattern matching and determining that the input image data is a special or copy-inhibited document when the input image data is found to contain the previously stored specific mark. Published Japanese patent application No. 2001-86330 also describes a similar technique. If an input original is determined to be a special document in this way, an unauthorized reproduction of this document is prevented. As another example, published Japanese patent application No. 7-36317 describes a technique for recognizing a confidential document as a copy-inhibited document by detecting a specific mark, such as, for example, “CONFIDENTIAL” and “NO COPYING”printed on the confidential document. A print of such a specific mark indicating a document's confidentiality is a common practice used in the above-described published Japanese patent application. When an input original is determined to be a special document in this way, unauthorized reproduction of the document can be prevented. Published Japanese patent application No. 7-87309 also describes a similar method.

Published Japanese patent application Nos. 9-164739 and 2001-197297 also describe a similar technique for inhibiting document reproduction by embedding a watermark in an original image requiring copy protection. This technique uses a paper document having a specific background image to which an original image is attached. The specific background image includes a watermark pattern having a base area and a message area. The watermark pattern is inconspicuous in comparison with the original image and therefore it does not render the original image unreadable. This technique causes the watermark pattern to appear when the original image having this watermark pattern is copied. The watermark pattern of this technique includes a warning such as “NO COPYING”, so that a copy of this original document is recognized easily at a glance as a confidential document which is intended to be protected from copying. Therefore, this technique has a psychological effect that tends to inhibit a person from copying a confidential document.

It is desirable to provide an image processing apparatus that detects a copy-inhibited document with accuracy, prevents the copy-inhibited document from being copied, and securely controls the information with respect to the copy-inhibited document while authorizing an operator as an administrator of the image processing apparatus.

It is further desirable to provide an image processing method for detecting a copy-inhibited document with accuracy, preventing the copy-inhibited document from being copied, and securely controlling the information with respect to the copy-inhibited document while authorizing an operator as an administrator of the image processing apparatus.

It is further desirable to provide a computer program product stored on a computer readable storage medium for executing the above-described image processing method.

It is further desirable to provide a computer readable medium storing computer instructions for performing the above-described image processing method.

### BRIEF SUMMARY OF THE INVENTION

According to an aspect of the present invention, an image processing apparatus includes: an image obtaining device configured to obtain image data of an original image, an image output device configured to output the image data obtained by the image obtaining device, an initial parameter setting device configured to set initial parameters with respect to a detection of a copy-inhibited document before obtaining the image data, a background dot pattern extracting device configured to extract at least one background dot pattern embedded in a background image included in the image data of the original image, and a copy-inhibited background dot pattern storing device configured to store a copy-inhibited background dot pattern. The image processing apparatus further includes a pattern match detecting device configured to compare the at least one background dot pattern extracted by the background dot pattern extracting device with the copy-inhibited background dot pattern stored in the copy-inhibited background dot pattern storing device and to detect a match between the at least one background dot pattern and the copy-inhibited background dot pattern, an image output inhibiting device configured to inhibit an output of the image data by the image output device when the pattern match detecting device detects the match between the at least one background dot pattern and the copy-inhibited background dot pattern, an image-output-inhibition notifying device configured to notify an inhibition of the output of the image data when the pattern match detecting device detects the match between the at least one background dot pattern and the copy-inhibited background dot pattern, a cancellation receiving device configured to receive cancellation of the inhibition of the output of the image data, and a canceling device configured to cancel the inhibition of the output of the image data when the cancellation receiving device receives the cancellation of the inhibition of the output of the image data.

According to another aspect of the present invention, an image processing method includes setting initial parameters with respect to a detection of a copy-inhibited document, obtaining image data of an original image, extracting at least one background dot pattern embedded in a background image included in the image data of the original image, detecting a match between the at least one background dot pattern and a copy-inhibited background dot pattern while comparing the at least one background dot pattern with the copy-inhibited background dot pattern, inhibiting an output of the image data when the match between the at least one background dot pattern and the copy-inhibited background dot pattern is detected, notifying an inhibition of the output of the image data when the match between the at least one background dot pattern and the copy-inhibited background dot pattern is detected, receiving cancellation of the inhibition of the output of the image data, and canceling the inhibition of the output of the image data when the cancellation of the inhibition of the output of the image data is received.

According to another aspect of the present invention, a computer program product stored on a computer readable storage medium for, when run on an image processing apparatus, carrying out an image processing method, which includes setting initial parameters with respect to a detection of a copy-inhibited document, obtaining image data of an original image, extracting at least one background dot pattern embedded in a background image included in the image data of the original image, detecting a match between the at least one background dot pattern and a copy-inhibited background dot pattern while comparing the at least one background dot pattern with the copy-inhibited background dot pattern, inhibiting an output of the image data when the match between the at least one background dot pattern and the copy-inhibited background dot pattern is detected, notifying an inhibition of the output of the image data when the match between the at least one background dot pattern and the copy-inhibited background dot pattern is detected, receiving cancellation of the inhibition of the output of the image data, and canceling the inhibition of the output of the image data when the cancellation of the inhibition of the output of the image data is received.

According to yet another aspect of the present invention, a computer readable medium storing computer instructions for performing an image processing method, includes setting initial parameters with respect to a detection of a copy-inhibited document, obtaining image data of an original image, extracting at least one background dot pattern embedded in a background image included in the image data of the original image, detecting a match between the at least one background dot pattern and a copy-inhibited background dot pattern while comparing the at least one background dot pattern with the copy-inhibited background dot pattern, inhibiting an output of the image data when the match between the at least one background dot pattern and the copy-inhibited background dot pattern is detected, notifying an inhibition of the output of the image data when the match between the at least one background dot pattern and the copy-inhibited background dot pattern is detected, receiving cancellation of the inhibition of the output of the image data, and canceling the inhibition of the output of the image data when the cancellation of the inhibition of the output of the image data is received.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of an image processing apparatus according to an embodiment of the present invention;

FIG. 2 is an illustration showing an exemplary copy-inhibited original document;

FIG. 3 is an enlarged illustration of a part of a watermark pattern embedded in an original image of the copy-inhibited original document of FIG. 2;

FIG. 4 is an enlarged illustration of another part of the watermark pattern embedded in an original image of the copy-inhibited original document of FIG. 2;

FIG. 5A is an illustration showing one exemplary reproduction of the copy-inhibited original document of FIG. 2;

FIG. 5B is an illustration showing another exemplary reproduction of the copy-inhibited original document of FIG. 2;

FIG. 6 is a block diagram of an image processing apparatus according to an embodiment of the present invention;

FIG. 7 is a block diagram of a watermark pattern detector;

FIG. 8 is a block diagram of an image processing apparatus according to an another embodiment of the present invention;

FIG. 9 is a block diagram of an image processing apparatus according to another embodiment of the present invention;

FIG. 10 is a block diagram of an image processing apparatus according to another embodiment of the present invention;

FIGS. 11A and 11B are flowcharts of an exemplary procedure of a copy-inhibited document determination operation performed by the image processing apparatus of FIG. 10;

FIG. 12 is a block diagram of an image processing apparatus according to an another embodiment of the present invention; and

FIG. 13 is a block diagram of an image processing apparatus according to another embodiment of the present invention.

### DETAILED DESCRIPTION OF THE INVENTION

Preferred embodiments of the present invention are described in detail referring to the drawings, wherein like reference numerals designate identical or corresponding parts throughout the several views.

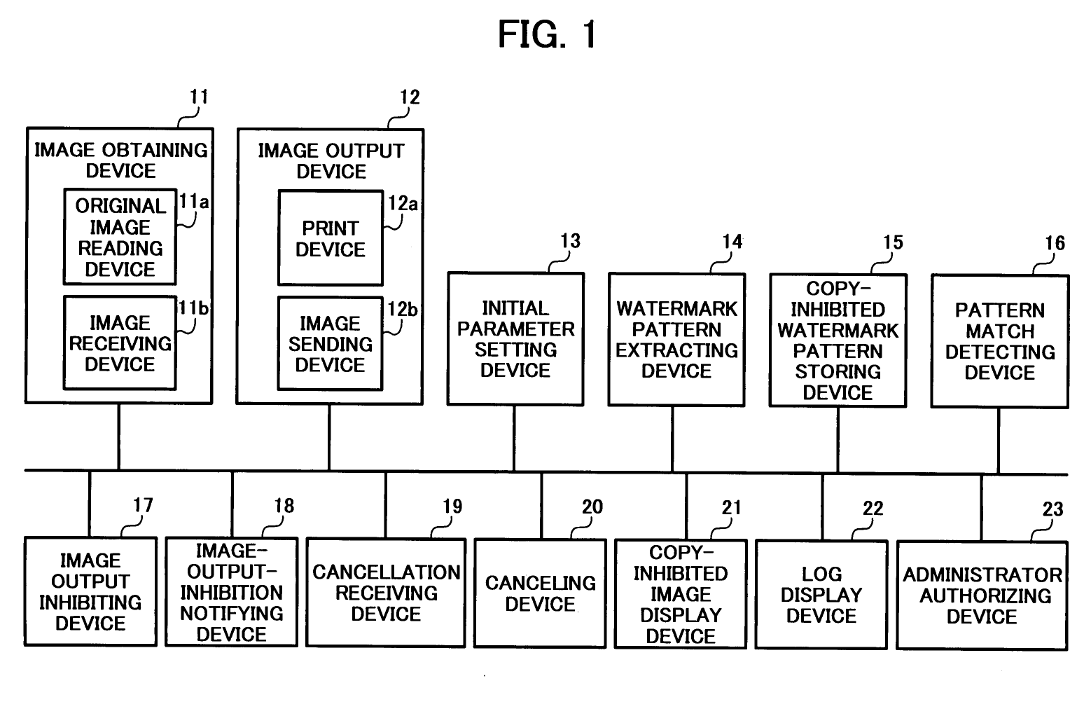

FIG. 1 is a block diagram of an image processing apparatus according to one embodiment of the present invention. The image processing apparatus of FIG. 1 is representative of image processing apparatuses 300a through 300f (described below). Referring to FIG. 1, an image processing apparatus includes an image obtaining device 11, an image output device 12, an initial parameter setting device 13, a watermark pattern extracting device 14, a copy-inhibited watermark pattern storing device 15, a pattern match detecting device 16, an image output inhibiting device 17, an image-output-inhibition notifying device 18, a cancellation receiving device 19, a canceling device 20, a copy-inhibited image display device 21, a log display device 22, and an administrator authorizing device 23.

The image obtaining device 11 obtains image data of an image of an original document (hereinafter simply referred to as an “original image”), and includes an original image reading device 11a and an image receiving device 11b. The original image reading device 11a reads an original image by a scanner. The image receiving device 11b receives image data from an external device (not show), such as, for example, a personal computer and another image processing apparatus, via a communication line. The image output device 12 outputs the image data obtained by the image obtaining device 11, and includes a print device 12a and an image sending device 12b. The print device 12a prints the image data obtained by the image obtaining device 11. The image sending device 12b sends the image data obtained by the image obtaining device 11 to an external device (not shown), such as, for example, a personal computer and another image processing apparatus, via a communication line.

The initial parameter setting device 13 sets initial parameters with respect to a detection of a copy-inhibited document (described below) before obtaining image data. The watermark pattern extracting device 14 extracts at least one watermark pattern embedded in a background image included in image data of an original image. The copy-inhibited watermark pattern storing device 15 stores a copy-inhibited watermark pattern. The pattern match detecting device 16 compares the at least one watermark pattern extracted by the watermark pattern extracting device 14 with the copy-inhibited watermark pattern stored in the copy-inhibited watermark pattern storing device 15, and detects a match therebetween.

The image output inhibiting device 17 inhibits the output of the image data by the image output device 12 when the pattern match detecting device 16 detects a match between the at least one watermark pattern and the copy-inhibited watermark pattern. The image-output-inhibition notifying device 18 notifies an inhibition of the output of the image data when the pattern match detecting device 16 detects the match between the at least one watermark pattern and the copy-inhibited watermark pattern. The cancellation receiving device 19 receives cancellation of an inhibition of the output of the image data. The canceling device 20 cancels the inhibition of the output of the image data when the cancellation receiving device 19 receives the cancellation of the inhibition of the output of the image data.

The copy-inhibited image display device 21 displays an image with respect to the image data inhibited from being output by the image output inhibiting device 17. The log display device 22 displays a log including internal information of the image processing apparatus and external information input to the image processing apparatus (described below). The administrator authorizing device 23 authorizes an administrator of the image processing apparatus based on, for example, a user ID, a password, an IC card, and biometrics information (described below).

Hereinafter, an operation of the image processing apparatus according to an embodiment of the present invention will be described in detail.

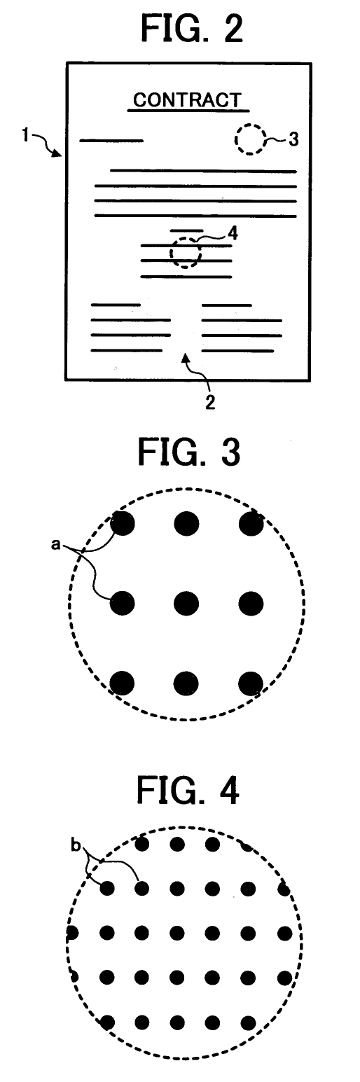

FIG. 2 illustrates an exemplary copy-inhibited original document 1, that is, a printed contract document in which a watermark pattern 2, which is not easily recognized with human eyes, is embedded as a background dot pattern in a background image included in the image data of an original image. In the original document 1 of FIG. 2, dots are arranged in a lattice point state in the watermark pattern 2. FIG. 3 is an enlarged illustration of a part 3 of the watermark pattern 2 of FIG. 2, and FIG. 4 is an enlarged illustration of a part 4 of the watermark pattern 2 of FIG. 2. The watermark pattern 2 is made of large-sized dots (a) illustrated in FIG. 3 and small-sized dots (b) illustrated in FIG. 4. The diameter of a minimum dot, which can be read by a scanner and a copying machine, is set to be greater than the diameter of the dot (b) and less than the diameter of the dot (a).

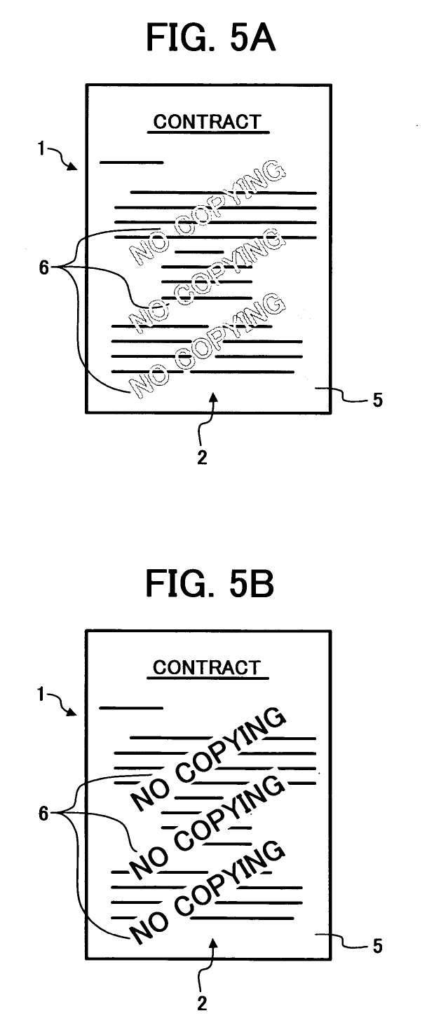

Referring to FIGS. 5A and 5B, the watermark pattern 2 includes a base area 5 and a plurality of message areas 6. The base area 5 represents a background area which is a major portion of the watermark pattern. The message areas 6 are the areas distributed within the base area 5 for expressing messages, such as, “NO COPYING”. Any other words, phrases, letters, symbols, logos, etc. can be expressed in the message areas 6.

Assuming that the base area 5 is made of the large-sized dots (a) in FIG. 3 and the message areas 6 are made of the small-sized dots (b) in FIG. 4, when a copy is made from the original document 1 of FIG. 2 by a copying machine, the base area 5 shows up and, as a result, the words “NO COPYING” appear in outline character form as illustrated in FIG. 5A. When the base area 5 is made of the small-sized dots (b) and the message areas 6 are made of the large-sized dots (a), the images in the message areas 6 show up and, as a result, the words “NO COPYING” appear in solid character form as illustrated in FIG. 5B.

As an alternative to the dot pattern, the watermark pattern 2 may use other patterns, such as, a line pattern, a specific design pattern, and so forth to form the images in the base area 5 and the message areas 6. The present exemplary embodiment deals with one of the base area 5 and the message areas 6 in quantitative characteristic. For example, when the image showing up is made of dots as described above, it is expressed by a characteristic, such as, a size, a density (i.e., the number of dots per a unit area), or the like. When the image showing up is made of thin lines, it is expressed by a characteristic, such as, width of the lines, a density of lines (i.e., the number of lines per a unit area), or the like. In this embodiment, the number of dots per a unit area (i.e., a dot density) in the base area 5 is set as a characteristic quantity in the base area 5. Similarly, the number of dots per a unit area (i.e., a dot density) in the message areas 6 is set as a characteristic quantity in the message areas 6. As described above, in this embodiment, the watermark pattern 2 as a background dot pattern is constructed from the base area 5 and the message areas 6 by using two kinds of dots. Alternatively, the watermark pattern 2 may be constructed from one kind of watermark pattern, such as, “+”, “-”, and the like.

As an alternative, it is possible to deal with one of the images in the base area 5 and the message areas 6, which are not shown as data expressed in a quantitative characteristic. It is further possible to deal with both of the images in the base area 5 and the message areas 6, which appear and do not appear upon copying, as data expressed in the respective characteristic quantities. In other words, when at least one of the images in the base area 5 and the message areas 6 is computer-readable data, these images can be handled as data expressed in the respective characteristic quantities when the original image printed on the original document 1 is read.

As described above, it is also possible to use a background dot pattern different from the watermark pattern 2. For example, the pattern of the base area 5 or the message areas 6 in the watermark pattern 2 can be used as an alternative background dot pattern. In this case, when the pattern of the base area 5 or the message areas 6 is computer-readable data, the pattern can also be handled as data expressed in the corresponding characteristic quantity when the original image printed on the original document 1 is read.

An exemplary image processing method according to an embodiment of the present invention is now described. The image processing method uses hardware resources including digital circuits, a computer, and so forth in order to perform a step of detecting, from image data, at least one of the images in the base area 5 and the message areas 6 included in the watermark pattern 2, embedded in a background image included in the image data of the original image of the original document 1. This detecting step detects the characteristics of the above-described watermark pattern 2, that is, the dot density, the line width, the design pattern, and so forth, for example. After this detecting step, the image processing method performs a step of comparing the detected watermark pattern 2 with a reference watermark pattern prepared as a copy-inhibited background dot pattern which is stored in a memory area (not shown) and determining whether the detected watermark pattern 2 is substantially identical to the reference watermark pattern, using the hardware resources. This step is referred to as an identity determination step.

More specifically, the identity determination step determines whether a difference between the characteristic quantities (e.g., the dot density) of the detected watermark pattern 2 and the reference watermark pattern is smaller than a predetermined threshold value. That is, when the difference is determined as smaller than the predetermined threshold value, the identity determination step determines that the detected watermark pattern 2 is substantially identical to the reference watermark pattern. Therefore, by previously storing the above-described reference watermark pattern as the copy-inhibited background dot pattern in the memory, the present embodiment can check whether the detected watermark pattern 2 is identical to such a reference watermark pattern so as to determine whether to inhibit an output of the image data of the original image of the original document 1.

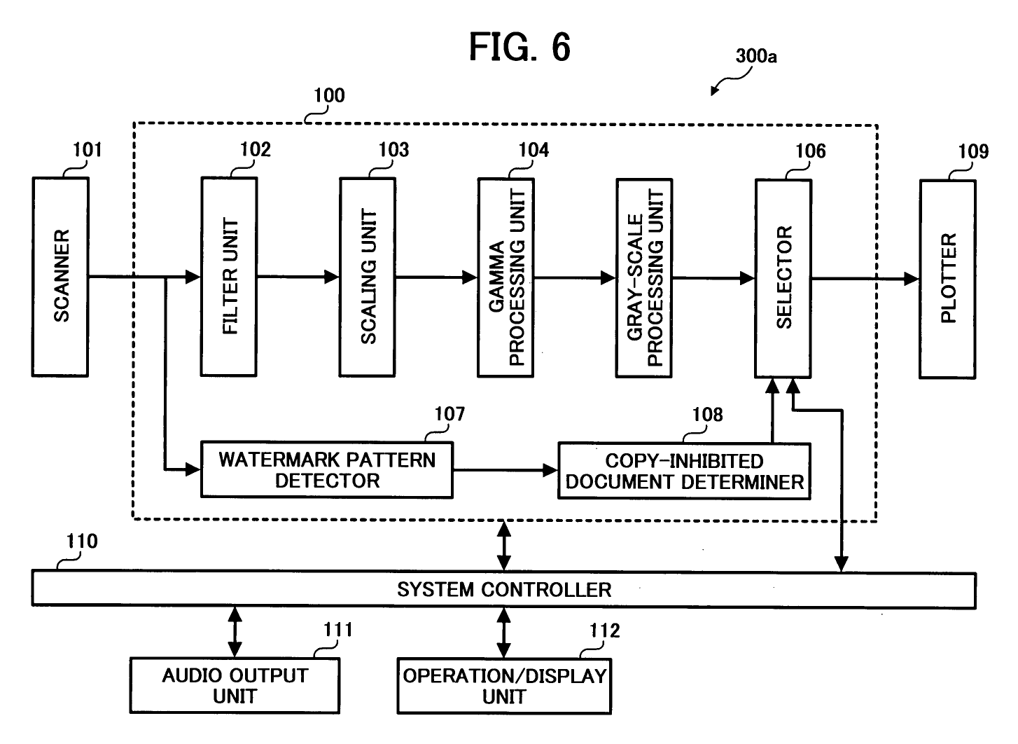

FIG. 6 is a block diagram of an image processing apparatus 300a according to an embodiment of the present invention. In FIG. 6, the image processing apparatus 300a is a digital copying machine and includes a scanner 101, an image processing unit 100, a plotter 109, a system controller 110, an audio output unit 111, and an operation/display unit 112. The image processing unit 100 includes a filter unit 102, a scaling unit 103, a gamma processing unit 104, a gray-scale processing unit 105, a selector 106, a watermark pattern detector 107, and a copy-inhibited document determiner 108. The scanner 101 functions as the original image reading device 11a of the image obtaining device 11 of FIG. 1. The watermark pattern detector 107 functions as the watermark pattern extracting device 14 in FIG. 1. The copy-inhibited document determiner 108 functions as the pattern match detecting device 16 in FIG. 1. The plotter 109 functions as the printing device 12a of the image output device 12 of FIG. 1. The system controller 110 controls other devices in FIG. 1 in cooperation with a central processing unit (CPU) (not shown), a read only memory (ROM) (not shown), and a program stored in a random access memory (RAM) (not shown). By using computing functions achieved with these components, the system controller 110 controls the operations of the scanner 101, the image processing unit 100, and the plotter 109 in accordance with instructions input through the operation/display unit 112 and displays necessary information on the operation/display unit 112. The audio output unit 111 functions as the image-output-inhibition notifying device 18 of FIG. 1. The operation/display unit 112 performs all or a part of respective functions of the image output inhibiting device 17, the image-output-inhibition notifying device 18, the cancellation receiving device 19, the copy-inhibited image display device 21, and the log display device 22 of FIG. 1. However, each function of the devices in FIG. 1 is not limited to a hardware structure of the image processing apparatus in FIG. 6.

When an original image is read by the scanner 101, image data of the read original image is sequentially transmitted to the filter unit 102, and the watermark pattern detector 107 detects the watermark pattern 2 in the original document 1.

The image data processed in the filter unit 102 is scaled at any desired scaling ratio in the scaling unit 103, and is subjected to a gamma correction in the gamma processing unit 104. Subsequently, the image data is subjected to a gray-scale processing in the gray-scale processing unit 105, and is transmitted to the selector 106.

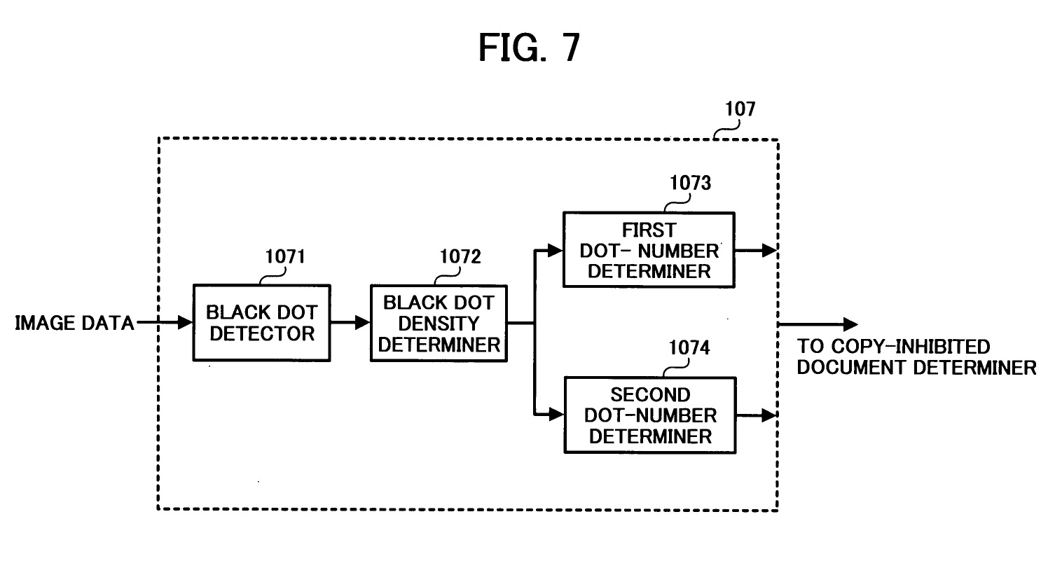

The watermark pattern detector 107 has an exemplary hardware structure as illustrated in FIG. 7, including a black dot detector 1071, a black dot density determiner 1072, a first dot-number determiner 1073, and a second dot-number determiner 1074. The watermark pattern detector 107 detects dots from the image data generated based on readings of the original image of the original document 1 by the scanner 101. A detection method is selected from among various known techniques for detecting image patterns with digital circuits, such as a pattern matching technique, for example. After detection of dots, the black dot density determiner 1072 calculates a dot density within a specific area with respect to the dots detected by the black dot detector 1071. This calculation can be performed using digital counters, adders, and so on.

In the watermark pattern detector 107, both the first dot-number determiner 1073 and the second dot-number determiner 1074 include a memory area (not shown). The first dot-number determiner 1073 stores first and second base area threshold values. The first base area threshold value is used by the first dot-number determiner 1073 as a permissible value in the identity determination relative to a dot density in a specific unit area of the base area 5 in the reference watermark pattern indicating the copy-inhibited background dot pattern. Based on this first base area threshold value, the black dot density determiner 1072 performs the dot density calculation. The second base area threshold value is used by the first dot-number determiner 1073 as a permissible value in the identity determination relative to a dot number in a specific unit area of the base area 5 in the reference watermark pattern 2 indicating the copy-inhibited mark which is included in the original document 1.

The second dot-number determiner 1074 stores first and second message area threshold values. The first message area threshold value is used by the second dot-number determiner 1074 as a permissible value in the identity determination relative to a dot density in a specific unit area of the message area 6 in the reference watermark pattern 2 prepared as the copy-inhibited background dot pattern. Based on this first message area threshold value, the black dot density determiner 1072 performs the dot density calculation. The second message area threshold value is used by the second dot-number determiner 1074 as a permissible value in the identity determination relative to a dot number in a specific unit area of the message area 6 in the reference watermark pattern 2 indicating the copy-inhibited mark which is included in the original document 1.

The first dot-number determiner 1073 accumulates the number of dots in a counter (not shown), for example, which are determined as the identical size by the black dot detector 1071. The first dot-number determiner 1073 increments the counter during operations to determine whether the density of dots calculated by the black dot density determiner 1072 is smaller than the first base area threshold value stored in the memory. The first dot-number determiner 1073 then determines that the base area 5 of the copy- inhibited watermark pattern 2 exists when the accumulated dot number is found to be smaller than the second base area threshold value stored in the memory. The first dot- number determiner 1073 transmits the determination result to the copy-inhibited document determiner 108.

The second dot-number determiner 1074 accumulates the number of dots in a counter (not shown), for example, which are determined as the identical size by the black dot detector 1071. The second dot-number determiner 1074 increments the counter during operations to determine whether the density of dots calculated by the black dot density determiner 1072 is smaller than the first message area threshold value stored in the memory. The second dot-number determiner 1074 then determines that the message area 6 of the copy-inhibited watermark pattern 2 exists when the accumulated dot number is found to be smaller than the second message area threshold value stored in the memory. The second dot-number determiner 1074 transmits the determination result to the copy- inhibited document determiner 108.

Upon receiving the determination result from the watermark pattern detector 107, the copy-inhibited document determiner 108 performs the determination process for determining whether the present document is a copy-inhibited document with reference to a predetermined standard. This standard can be, for example, established by being input as parameters through the operation/display unit 112 and stored in a memory area (not shown) of the copy-inhibited document determiner 108. For example, the copy-inhibited document determiner 108 determines that the present document is a copy-inhibited document, e.g., a confidential document, upon determining that one of the base area 5 and the message area 6 of the watermark pattern 2 exists in the image of the original document 1 read by the scanner 101. In another example, the copy-inhibited document determiner 108 determines that the present document is a copy-inhibited document, e.g., a confidential document, upon determining that both of the base area 5 and the message area 6 of the watermark pattern 2 exist in the image of the original document 1 read by the scanner 101.

When the copy-inhibited document determiner 108 is set to determine that the present document is a copy-inhibited document when one of the base area 5 and the message area 6 of the watermark pattern 2 is determined as existing in the image of the original document 1, it is not necessary to provide both the first dot-number determiner 1073 and the second dot-number determiner 1074 in the watermark pattern detector 107. When the base area 5 is used and the message area 6 is not used for the copy-inhibited document determining condition, the watermark pattern determiner 107 includes only the first dot-number determiner 1073. Alternatively, when the message area 6 is used and the base area 5 is not used for the copy-inhibited document determining condition, the watermark pattern determiner 107 includes only the second dot-number determiner 1074.

Thus, the present embodiment detects from the image data whether or not the watermark pattern 2 is embedded in the background image included in image data of an original image of the original document 1. If so, the present embodiment compares the detected watermark pattern 2 to the prestored reference copy-inhibited watermark pattern, thereby performing the watermark pattern identity determination. With this operation, the present embodiment can determine whether it is permissible to output the image data of the original image of the original document 1.

When the copy-inhibited document determiner 108 determines that the original image of the original document 1 read by the scanner 101 is a copy-inhibited document, the copy-inhibited document determiner 108 transmits information indicating that a copy-inhibited document is detected to the selector 106. In response to the transmitted information, the selector 106 selects a post-copy-inhibited document detection operation for inhibiting the reproduction operation of the plotter 109 with respect to the copy-inhibited document. In this condition, an operation of a copying machine is stopped. Alternatively, a white paper without an image may be output from the plotter 109. Further, a prohibiting message, for example, “This document cannot be copied: Copy prohibited” is displayed on the operation/display unit 112 for warning an operator. Alternatively, the audio output unit 111 may produce an audible message, for example, “This document is inhibited” for warning an operator. With such a warning message from the operation/display unit 112 or the audio output unit 111, the operator can surely recognize that an original document to be copied is a copy-inhibited document. Further, the operator is prevented from erroneously determining that the copying machine malfunctions. Thus, the operation/display unit 112 and the audio output unit 111 function as the image-output-inhibition notifying device 18 of FIG. 1.

When the original document 1 is determined as not a copy-inhibited document, i.e., an ordinary document, the selector 106 selects an ordinary reproduction operation of the plotter 109.

In order to set initial parameters by the initial parameter setting device 13 of FIG. 1 before reading an original image by the scanner 101, an operator is required to be authorized as an administrator. Further, an operator is required to be authorized as an administrator when the operator operates the operation/display unit 112 under the condition that the reproduction operation of the plotter 109 is inhibited after an original document is detected as a copy-inhibited document. For example, an operator is authorized as an administrator to operate the operation/display unit 112 when a user identification (ID) and a password entered on the operation/display unit 112 match with authorizing information stored in a memory (not shown) of the system controller 110. The user ID and password entered on the operation/display unit 112 are stored in a log file (not shown) of the image processing apparatus 300a.

The authorized operator can select and set a copy-inhibited document detection mode as initial parameters via the operation/display unit 112 for performing a copy-inhibited document detection operation. The setting of the copy-inhibited document detection mode is stored in the memory of the system controller 110. When the authorized operator selects an ordinary copy mode as initial parameters, an original document is copied without the copy-inhibited document detection operation.

As exemplary initial parameters set by the authorized operator for the copy-inhibited document detection operation, the operator can set the above-described threshold values used in the identity determination depending on the conditions and environment of use and so forth. When the threshold values are strictly set, a copy-inhibited document can be detected with higher accuracy. When the possibility of copying inhibited documents is low, the threshold values are not strictly set to minimize an occurrence that an ordinary document is mistaken for a copy-inhibited document.

As another example of initial parameters set by the authorized operator for the copy-inhibited document detection operation, the operator can select the above-described warning message output from the operation/display unit 112 or the audio output unit 111. The data of the initial parameters is stored in the memory of the system controller 110 and the log file of the image processing apparatus 300a.

When a copy-inhibited document is detected, a thumbnail image made by scaling down image data of an image of the copy-inhibited document is stored in the log file of the image processing apparatus 300a. An authorized operator can check the image of the copy-inhibited document while viewing its thumbnail image displayed on the operation/display unit 112 at any desired timing. In this case, the operation/display unit 112 functions as the copy-inhibited image display device 21 of FIG. 1.

An authorized operator can check a log including internal information of the image processing apparatus 300a and external information input to the image processing apparatus 300a. Examples of the internal information include the time and date when an image of a copy-inhibited document is read by the scanner 101, a type of detected copy-inhibited document, and a serial number of the image processing apparatus 300a. Examples of the external information include a size of a sheet used for copying, a user ID, initial parameters, which are set by an operator, including image processing mode information, such as, a photograph mode and a character mode. The log can be displayed on the operation/display unit 112, and output on a sheet if necessary. Thus, the operation/display unit 112 also functions as a log display device 22 of FIG. 1.

Further, the authorized operator can cancel or invalidate the inhibition of the output of the image data in the image processing apparatus 300a. Specifically, the operation/display unit 112 functioning as the cancellation receiving device 19 of FIG. 1 receives a cancellation instruction from an operator. When the operation/display unit 112 receives a cancellation instruction from an operator, the operator is required to be authorized as an administrator, for example, based on the above-described user ID and password input to the operation/display unit 112. Subsequently, the canceling device 20 of FIG. 1 cancels the inhibition of the output of the image data, that is, resets the image processing apparatus 300a. As a result, a copy operation can be performed again in the image processing apparatus 300a. The information regarding the cancellation of inhibiting the output of the image data is stored in the log file of the image processing apparatus 300a.

Moreover, the authorized operator can cancel or invalidate the inhibition of the output of the image data in the image processing apparatus 300a, and can retrieve and output image data of an image of a copy-inhibited document. The information whether the authorized operator outputs the image data of the image of the copy-inhibited document is stored in the log file of the image processing apparatus 300a. The authorized operator can also delete the image data of the image of the copy-inhibited document stored in the memory of the system controller 101.

Thus, by checking the log, an operator can recognize various information regarding the inhibited copy operation of the image processing apparatus 300a, and can trace history information regarding the dealing with the image data of the image of the copy-inhibited document.

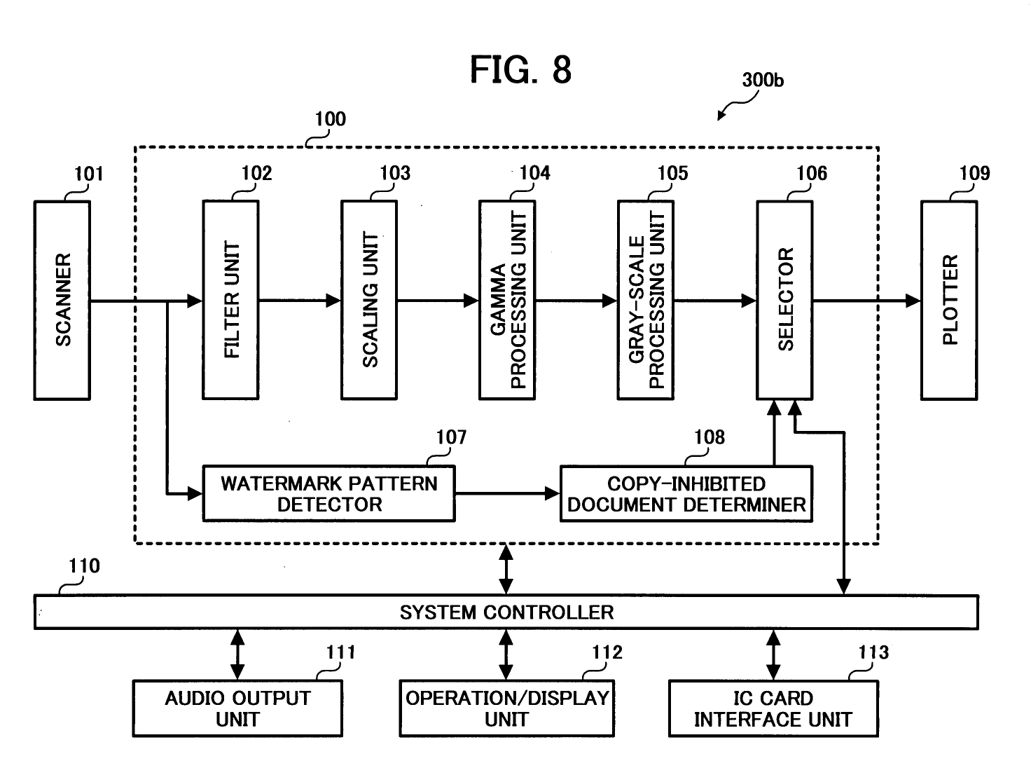

FIG. 8 is a block diagram of an image processing apparatus 300b according to another embodiment of the present invention. The construction of the image processing apparatus 300b of FIG. 8 is substantially similar to that of the image processing apparatus 300a of FIG. 6 except for an IC card interface unit 113. In the image processing apparatus 300b, an operator is authorized as an administrator to operate the operation/display unit 112 when the information of an IC card obtained via the IC card interface unit 113 matches with authorizing information stored in the memory of the image processing apparatus 300b. The authorization result is transmitted to the operation/display unit 112, so that the authorized operator can operate the operation/display unit 112. The authorizing information with regard to the IC card is stored in the log file of the image processing apparatus 300b.

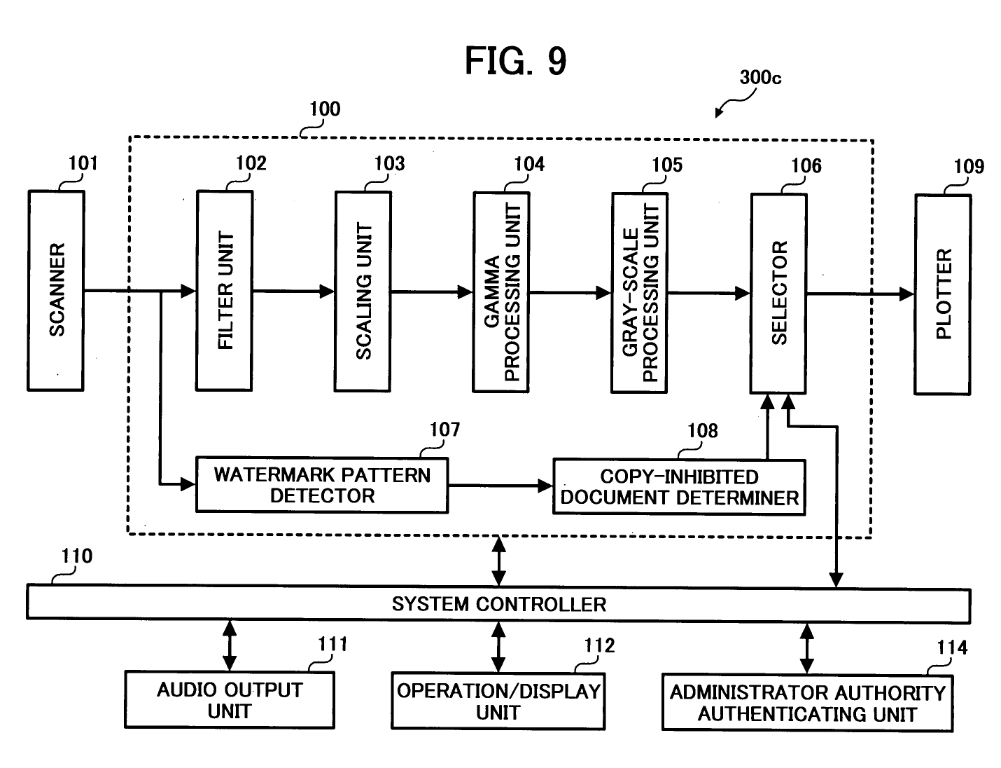

FIG. 9 is a block diagram of an image processing apparatus 300c according to another embodiment of the present invention. The construction of the image processing apparatus 300c of FIG. 9 is substantially similar to that of the image processing apparatus 300a of FIG. 6 except for an administrator authorizing unit 114. The administrator authorizing unit 114 is connected to the image processing apparatus 300c via an external interface unit (not shown). A device that identifies biometrics information, such as, for example, fingerprint, iris, face, and voice, is connected to the external interface unit. The biometrics information is pre-registered in the administrator authorizing unit 114. An operator is authorized as an administrator to operate the operation/display unit 112 when at least one of the biometrics information of the operator matches with the biometrics information registered in the administrator authorizing unit 114. The authorization result is transmitted to the operation/display unit 112, so that the authorized operator can operate the operation/display unit 112. The authorizing information with regard to the biometrics information is stored in the log file of the image processing apparatus 300c.

In the above-described embodiments, the administrator authorizing device 23 of FIG. 1 authorizes an administrator based on the information, such as, a user ID, a password, an IC card, biometrics information, and so forth.

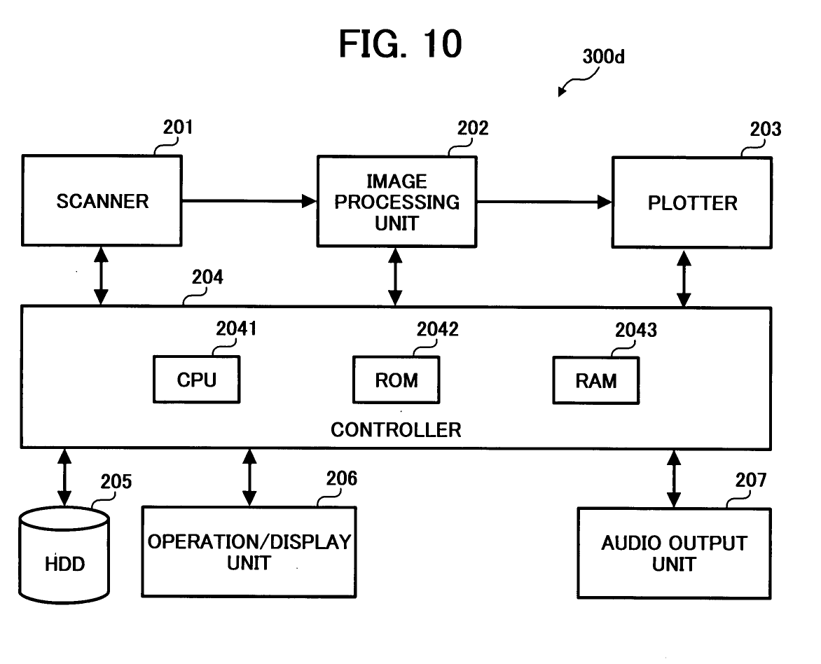

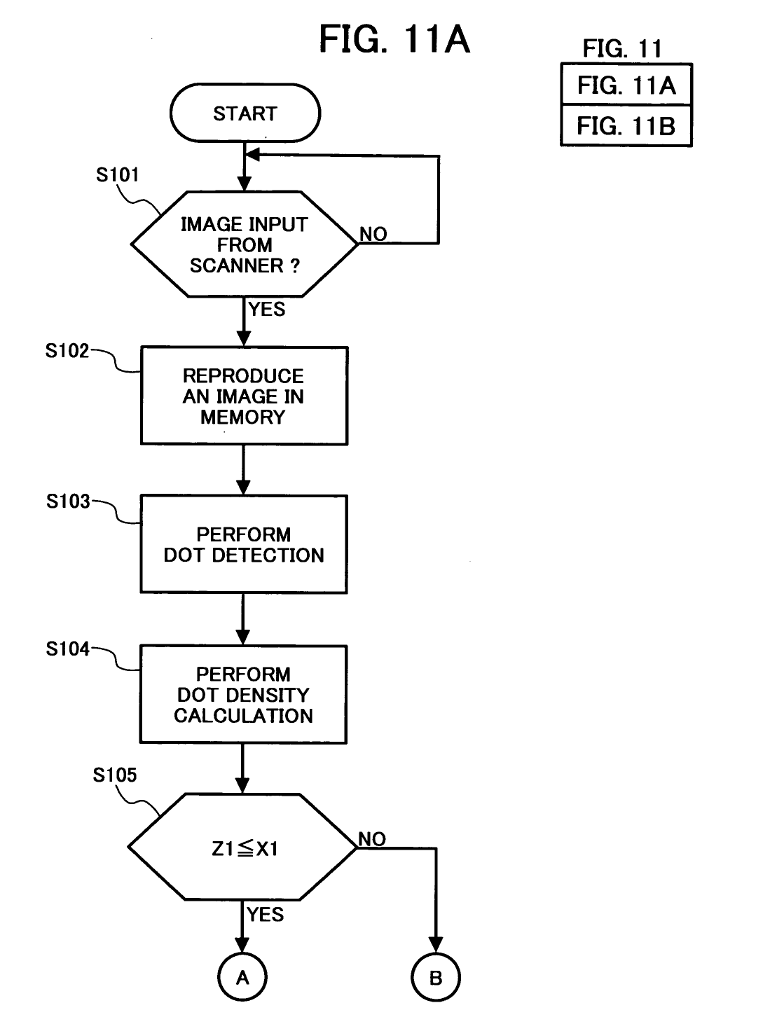

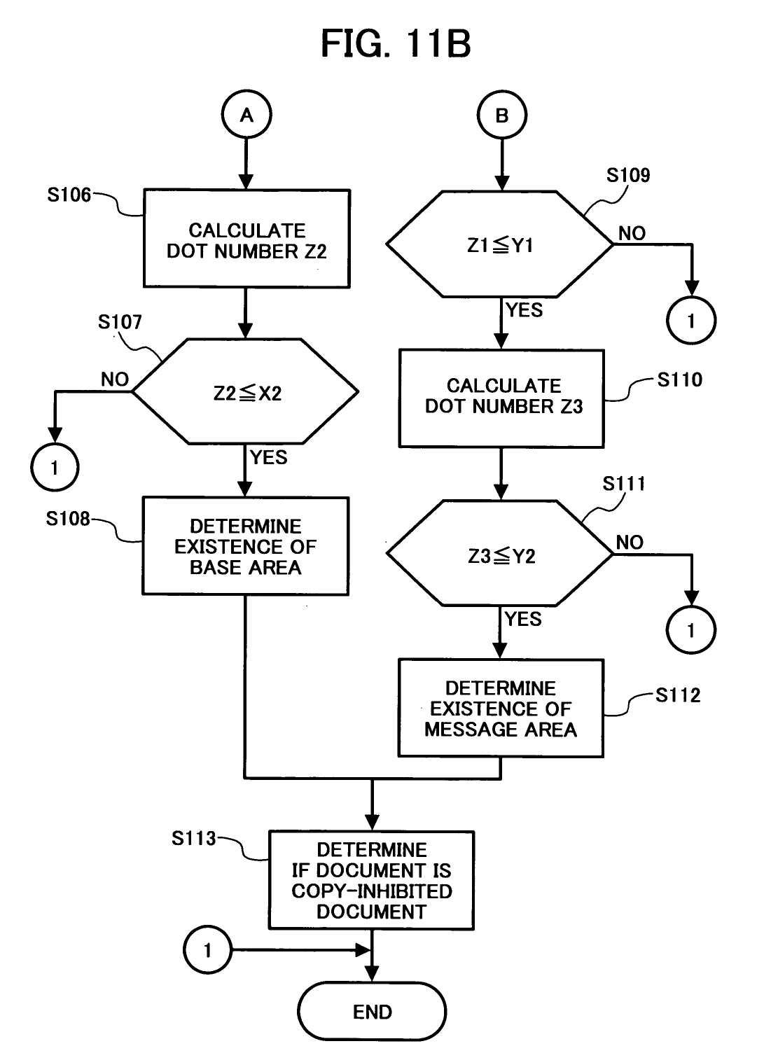

Next, an exemplary structure of an image processing apparatus 300d according to another embodiment of the present invention is explained referring to FIGS. 10, 11A, and 11B. As described above, the image processing apparatuses 300a, 300b, and 300c of FIGS. 6, 8, and 9 perform exemplary copy protection operations which use hardware resources to detect a copy-inhibited document and perform copy protection processing based on the detection result. The image processing apparatus 300d of FIG. 10 includes software resources for performing copy protection operations after detecting a copy-inhibited document, which is further described below.

As illustrated in FIG. 10, the image processing apparatus 300d includes a scanner 201, an image processing unit 202, a plotter 203, a controller 204, a hard disc drive (HDD) 205, an operation/display unit 206, and an audio output unit 207. Unlike the image processing unit 100 of FIGS. 6, 8, and 9, the image processing unit 202 of FIG. 10 does not include the watermark pattern detector 107 and the copy-inhibited document determiner 108. The controller 204 includes a central processing unit (CPU) 2041, a read only memory (ROM) 2042, and a random access memory (RAM) 2043. A computer program for performing copy protection operations is installed as firmware in the ROM 2042 of the controller 204. As an alternative, the computer program for performing copy protection operations may be installed in the HDD 205 connected to a micro computer configured by the CPU 2041, the ROM 2042, and the RAM 2043. In the image processing apparatus 300d, the controller 204 is a main unit to control the copy protection operation according to the copy protection program prestored in either the ROM 2042 or the HDD 205. In this embodiment, the ROM 2042 and the HDD 205 function as a computer readable medium (i.e., a computer program storage medium) storing computer instructions for performing an image processing method.

Referring to FIGS. 11A and 11B, an exemplary procedure of the copy-inhibited document determination operation performed by the image processing apparatus 300d is described. In step S101 of FIG. 11A, the CPU 2041 of the controller 204 repeatedly checks whether image data read from the original image of the original document 1 by the scanner 201 is input to the image processing unit 202. If the answer is YES in step S101, the CPU 2041 stores the input image data into a memory area of the RAM 2043 for storing image data in step S102. If the answer is NO in step S 101, the copy-inhibited document determination operation returns to re-execute step S101. Then, in step S103, the CPU 2041 detects dots from the image data stored in the RAM 2043 by a pattern matching method, for example. Subsequently, in step S104, the CPU 2041 calculates a dot density Z1 in a specific unit area of the detected dots.

In this embodiment, the RAM 2043 stores data including a first base area threshold value X1, a second base area threshold value X2, a first message area threshold value Y1, and a second message area threshold value Y2. The first base area threshold value X1 is a permissible value used in an identity determination relative to a dot density in a specific unit area of the base area 5 in the reference watermark pattern 2 prepared as the copy-inhibited background dot pattern. The second base area threshold value X2 is a permissible value used in an identity determination relative to a dot number in a specific unit area of the base area 5 in the reference watermark pattern 2 indicating the copy-inhibited mark included in the original document 1. The first message area threshold value Y1 is a permissible value used in an identity determination relative to a dot density in a specific unit area of the message area 6 in the reference watermark pattern 2 prepared as the copy-inhibited background dot pattern. The second message area threshold value Y2 is a permissible value used in an identity determination relative to a dot number in a specific unit area of the message area 6 in the reference watermark pattern 2 indicating the copy-inhibited mark included in the original document 1.

In step S105, the CPU 2041 determines whether the dot density Z1 in a specific unit area of the dots detected in step S103 is smaller than or equal to the first base area threshold value X1 stored in the RAM 2043, where X1 is greater than the dot density of the base area 5 included in the watermark pattern 2. If the answer is NO in step S105, the CPU 2041 determines whether the dot density Z1 in a specific unit area of the dots detected in step S103 is smaller than or equal to the first message area threshold value Y1 stored in the RAM 2043, where Y1 is greater than the dot density of the message area 6 included in the watermark pattern 2 in step S109.

If the answer is YES in step S105, the CPU 2041 performs a dot number calculation to accumulate the number of the detected dots in step S106. As a result of the accumulation, an accumulated dot number Z2 is generated and is stored in a registration memory area of the RAM 2043, for example. Then, in step S107, the CPU 2041 determines whether the accumulated dot number Z2 is smaller than or equal to the second base area threshold value X2 stored in the RAM 2043, where X2 is greater than the dot number in the base area 5 of the watermark pattern 2. If the answer is YES in step S107, the CPU 2041 determines that the base area 5 of the copy-inhibited watermark pattern 2 exists in step S108. After the step S108, the CPU 2041 transmits data indicating this determination result to a copy-inhibited document determination procedure in step S113.

If the answer is NO in step S107, the CPU 2041 determines that the base area 5 of the copy-inhibited watermark pattern 2 does not exist, and the copy-inhibited document determination operation ends.

If the answer is YES in step S109, the CPU 2041 performs a dot number calculation to accumulate the number of the detected dots in step S110. As a result of the accumulation, an accumulated dot number Z3 is generated and is stored in a registration memory area of the RAM 2043, for example. Then, in step S111, the CPU 2041 determines whether the accumulated dot number Z3 is smaller than or equal to the second message area threshold value Y2 stored in the RAM 2043, where Y2 is greater than the dot number in the message area 6 of the watermark pattern 2. If the answer is YES in step S111, the CPU 2041 determines that the message area 6 of the copy-inhibited watermark pattern 2 exists in step S112. After the step S112, the CPU 2041 transmits data indicating this determination result to the copy-inhibited document determination procedure in step S113. The CPU 2041 ends the copy-inhibited document determination operation in either of two cases when the answer is NO in steps S109 and S11.

In step S113, the CPU 2041 executes the copy-inhibited document determination processing with reference to a predetermined standard. This standard can be, for example, established by being input as parameters through the operation/display unit 206 and stored in the RAM 2043. With the thus-prepared exemplary standard, the copy-inhibited document determination processing of the CPU 2041 in step S113 determines that the present document is a copy-inhibited document when determining that one of the base area 5 and the message area 6 of the watermark pattern 2 exists in the image of the original document 1 read by the scanner 201. In another example, the copy-inhibited document determination processing by the CPU 2041 determines that the present document is a copy-inhibited document when determining that both of the base area 5 and the message area 6 of the watermark pattern 2 exist in the image of the original document 1 read by the scanner 201.

Thus, the present embodiment detects from the image data whether or not the watermark pattern 2 is embedded in the background image included in image data of an original image. If so, the present embodiment compares the detected watermark pattern 2 with the prestored reference copy-inhibited watermark pattern, thereby performing the watermark pattern identity determination. With this operation, the present embodiment can determine whether it is permissible to output the image data of the images of the original document 1.

The copy-inhibited document determination processing of the CPU 2041 in step S113 performs a post-copy-inhibited document detection operation when determining that the original document 1 scanned by the scanner 201 is a copy-inhibited document. The CPU 2041 prohibits the reproduction of the copy-inhibited document by the plotter 203. In this condition, the CPU 2041 inhibits an output of image data of the image of the copy-inhibited document, and stops an operation of the copying machine. Alternatively, the CPU 2041 causes a white paper without an image to be output from the plotter 203. Further, the CPU 2041 causes a prohibiting message, for example, “This document cannot be copied: Copy prohibited” to be displayed on the operation/display unit 206 for warning an operator. Alternatively, the CPU 2041 causes the audio output unit 207 to produce an audible message, for example, “This document is inhibited” for warning an operator. With such a warning message from the operation/display unit 206 or the audio output unit 207, the operator can surely recognize that an original document to be copied is a copy-inhibited document. Further, the operator is prevented from erroneously determining that the copying machine malfunctions. Thus, the operation/display unit 206 and the audio output unit 207 function as the image-output-inhibition notifying device 18 of FIG. 1.

When the original document 1 is determined as not a copy-inhibited document in the copy-inhibited document detection processing in step S113, the CPU 2041 causes the plotter 203 to perform the reproduction operation relative to the image data of the original image of the original document 1 stored in either the RAM 2043 or the HDD 205.

In order to set initial parameters by the initial parameter setting device 13 of FIG. 1 before reading an original image by the scanner 201, an operator is required to be authorized as an administrator. Further, an operator is required to be authorized as an administrator when the operator operates the operation/display unit 206 under the condition that the reproduction operation of the plotter 203 is inhibited after an original document is detected as a copy-inhibited document. For example, an operator is authorized as an administrator to operate the operation/display unit 206 when a user identification (ID) and a password entered on the operation/display unit 206 match with authorizing information stored in a memory area (not shown) of the image processing apparatus 300d. The user ID and password entered on the operation/display unit 206 are stored in the memory area and a log file (not shown) of the image processing apparatus 300d.

The authorized operator can select and set a copy-inhibited document detection mode as initial parameters via the operation/display unit 206 for performing a copy-inhibited document detection operation. The setting of the copy-inhibited document detection mode is stored in the memory of the controller 204. When the authorized operator selects an ordinary copy mode as initial parameters, an original document is copied without the copy-inhibited document detection operation.

As exemplary initial parameters set by the authorized operator for the copy-inhibited document detection operation, the operator can set the above-described threshold values used in the identity determination depending on the conditions and environment of use and so forth. When the threshold values are strictly set, a copy-inhibited document can be detected with higher accuracy. When the possibility of copying inhibited documents is low, the threshold values are not strictly set to minimize an occurrence that an ordinary document is mistaken for a copy-inhibited document.

As another example of initial parameters set by the authorized operator for the copy-inhibited document detection operation, the operator can select the above-described warning message output from the operation/display unit 206 or the audio output unit 207. The data of the initial parameters is stored in the memory area and the log file of the image processing apparatus 300d.

When a copy-inhibited document is detected, a thumbnail image made by scaling down image data of an image of the copy-inhibited document is stored in the log file of the image processing apparatus 300d. An authorized operator can check the image of the copy-inhibited document by viewing its thumbnail image displayed on the operation/display unit 206 at any desired timing. In this case, the operation/display unit 206 functions as the copy-inhibited image display device 21 of FIG. 1.

An authorized operator can check a log including internal information of the image processing apparatus 300d and external information input to the image processing apparatus 300d. Examples of the internal information include the time and date when an image of a copy-inhibited document is read by the scanner 201, a type of detected copy-inhibited document, and a serial number of the image processing apparatus 300d. Examples of the external information include a size of a sheet used for copying, a user ID, initial parameters, which are set by an operator, including image processing mode information, such as, a photograph mode and a character mode. The log can be displayed on the operation/display unit 206, and output on a sheet if necessary. Thus, the operation/display unit 206 also functions as a log display device 22 of FIG. 1.

Further, the authorized operator can cancel or invalidate the inhibition of the output of the image data in the image processing apparatus 300d. Specifically, the operation/display unit 206 functioning as the cancellation receiving device 19 of FIG. 1 receives a cancellation instruction from an operator. When the operation/display unit 206 receives a cancellation instruction from an operator, the operator is required to be authorized as an administrator, for example, based on the above-described user ID and password input to the operation/display unit 206. Subsequently, the canceling device 20 of FIG. 1 cancels the inhibition of the output of the image data, that is, resets the image processing apparatus 300d. As a result, a copy operation can be performed again in the image processing apparatus 300d. The information regarding the cancellation of inhibiting the output of the image data is stored in the log file of the image processing apparatus 300d.

Moreover, the authorized operator can cancel or invalidate the inhibition of the output of the image data in the image processing apparatus 300d, and can retrieve and output image data of an image of a copy-inhibited document. The information whether the authorized operator outputs the image data of the image of the copy-inhibited document is stored in the log file of the image processing apparatus 300d. The authorized operator can also delete the image data of the image of the copy-inhibited document stored in the memory area of the image processing apparatus 300d.

Thus, by checking the log, an operator can recognize various information regarding the inhibited copy operation of the image processing apparatus 300d, and can trace history information regarding the dealing with the image data of the image of the copy-inhibited document.

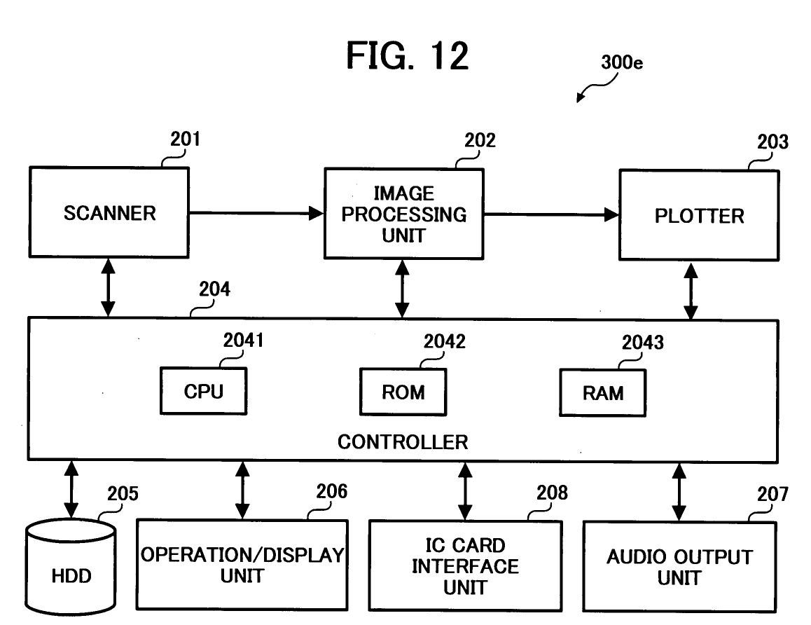

FIG. 12 is a block diagram of an image processing apparatus according to another embodiment of the present invention. The construction of an image processing apparatus 300e of FIG. 12 is substantially similar to that of the image processing apparatus 300d of FIG. 10 except for an IC card interface unit 208. In the image processing apparatus 300e, an operator is authorized as an administrator to operate the operation/display unit 206 when the information of an IC card obtained via the IC card interface unit 208 matches with authorizing information stored in the memory of the image processing apparatus 300e. The authorization result is transmitted to the operation/display unit 206, so that the authorized operator can operate the operation/display unit 206. The authorizing information with regard to the IC card is stored in the log file of the image processing apparatus 300e.

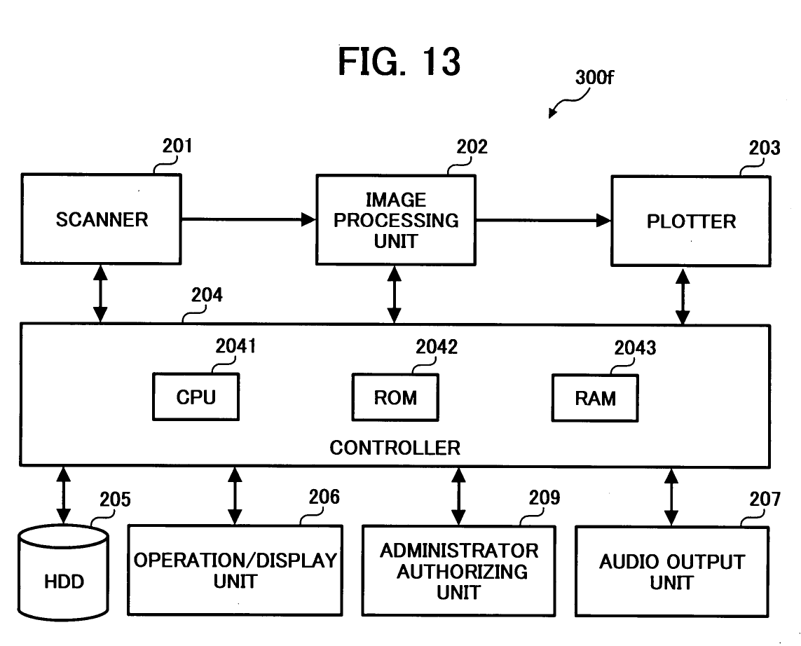

FIG. 13 is a block diagram of an image processing apparatus according to another embodiment of the present invention. The construction of an image processing apparatus 300f of FIG. 13 is substantially similar to that of the image processing apparatus 300d of FIG. 10 except for an administrator authorizing unit 209. The administrator authorizing unit 209 is connected to the image processing apparatus 300f via an external interface unit (not shown). A device that identifies biometrics information, such as, for example, fingerprint, iris, face, and voice, is connected to the external interface unit. The biometrics information is pre-registered in the administrator authorizing unit 209. An operator is authorized as an administrator to operate the operation/display unit 206 when at least one of the biometrics information, such as, fingerprint, iris, face, and voice of the operator matches with the biometrics information registered in the administrator authorizing unit 209. The authorization result is transmitted to the operation/display unit 206, so that the authorized operator can operate the operation/display unit 206. The authorizing information with regard to the biometrics information is stored in the log file of the image processing apparatus 300f.

In the above-described embodiments, the administrator authorizing device 23 of FIG. 1 authorizes an administrator based on the information, such as, a user ID, a password, an IC card, biometrics information, and so forth.

The above-described embodiments may be conveniently implemented using a conventional general purpose digital computer programmed according to the teachings of the present specification, as will be apparent to those skilled in the computer art. Appropriate software coding can readily be prepared by skilled programmers based on the teaching of the present disclosure, as will be apparent to those skilled in the software art. The present embodiments may also be implemented by the preparation of application specific integrated circuits or by interconnecting an appropriate network of conventional component circuits, as will be readily apparent to those skilled in the art.

In the image processing apparatus according to the above-described embodiments of the present invention, a copy-inhibited document is automatically detected with accuracy and is prevented from being copied. Further, an operator of the image processing apparatus is authorized as an administrator who is allowed to do several operations such as setting initial parameters and checking a copy-inhibited image and a log on the operation/display unit, canceling the inhibition of the output of the copy-inhibited document and outputting the copy-inhibited document, and deleting the image data of the image of the copy-inhibited document stored in the memory of the system controller. The operator is securely authorized as the administrator based on the information, such as, a user ID, a password, an IC card, biometrics information, and so forth. When a copy-inhibited document is detected, a warning message is output from the operation/display unit or the audio output unit. Therefore, an operator can surely recognize that an original document to be copied is a copy-inhibited document. Thus, the information with respect to the copy-inhibited document can be securely controlled. Therefore, the leakage of the information of the copy-inhibited document is effectively prevented.

The present invention has been described with respect to the exemplary embodiments illustrated in the figures. However, the present invention is not limited to these embodiments and may be practiced otherwise.

The present invention has been described with respect to a digital copying machine as an example of an image processing apparatus. However, the present invention may be applied to other similar image processing apparatuses, such as, a facsimile machine, an image filing apparatus, a scanner, etc.

Numerous additional modifications and variations of the present invention are possible in light of the above teachings. It is therefore understood that within the scope of the appended claims, the present invention may be practiced other than as specifically described herein.

What is claimed as new and desired to be protected by letters patent of the united states is:

1. An image processing apparatus, comprising:
an image obtaining device configured to obtain image data of an original image;
an image output device configured to output the image data obtained by the image obtaining device;
a background dot pattern extracting device configured to extract at least one background dot pattern embedded in a background image included in the image data of the original image;
a copy-inhibited background dot pattern storing device configured to store a copy-inhibited background dot pattern;
a pattern match detecting device configured to compare the at least one background dot pattern extracted by the background dot pattern extracting device with the copy-inhibited background dot pattern stored in the copy-inhibited background dot pattern storing device and to detect a match between the at least one background dot pattern and the copy-inhibited background dot pattern;
an image output inhibiting device configured to inhibit an output of the image data by the image output device when the pattern match detecting device detects the match between the at least one background dot pattern and the copy-inhibited background dot pattern; and
a canceling device configured to cancel the inhibition of the output of the image data.

2. The image processing apparatus according to claim 1 further comprising:
an initial parameter setting device configured to set initial parameters with respect to a detection of a copy-inhibited document before obtaining the image data;
an image-output-inhibition notifying device configured to notify an inhibition of the output of the image data when the pattern match detecting device detects the match between the at least one background dot pattern and the copy-inhibited background dot pattern; and
a cancellation receiving device configured to receive cancellation of the inhibition of the output of the image data and send said cancellation to the canceling device.

3. The image processing apparatus according to claim 1, wherein the image obtaining device comprises at least one of an original image reading device configured to read an original image by a scanner and an image receiving device configured to receive image data from an external device via a communication line.

4. The image processing apparatus according to claim 1, wherein the image output device comprises at least one of a print device configured to print the image data obtained by the image obtaining device and an image sending device configured to send the image data obtained by the image obtaining device to an external device via a communication line.

5. The image processing apparatus according to claim 2, wherein the image-output-inhibition notifying device has at least one of a displaying function and an audio output function.

6. The image processing apparatus according to claim 2, wherein the cancellation receiving device comprises an operation/display unit.

7. The image processing apparatus according to claim 1, further comprising a copy-inhibited image display device configured to display an image with respect to the image data inhibited from being output by the image output inhibiting device.

8. The image processing apparatus according to claim 1, further comprising a log display device configured to display a log including internal information of the image processing apparatus and external information input to the image processing apparatus.

9. The image processing apparatus according to claim 1, wherein the canceling device has a function of resetting the image processing apparatus, and when the image processing apparatus is reset by the canceling device, the image output device becomes ready for outputting the image data of the original image.

10. The image processing apparatus according to claim 1 further comprising an administrator authorizing device configured to authorize an administrator of the image processing apparatus.

11. The image processing apparatus according to claim 10, wherein the administrator authorizing device authorizes the administrator when the administrator sets an initial parameter to an initial parameter setting device.

12. The image processing apparatus according to claim 10, wherein the administrator authorizing device authorizes the administrator when a cancellation receiving device receives a request to cancel the inhibition of the output of the image data from the administrator.

13. The image processing apparatus according to claim 11, wherein the administrator authorizing device authorizes the administrator based on a user ID and a password.

14. The image processing apparatus according to claim 11, wherein the administrator authorizing device authorizes the administrator based on an IC card.

15. The image processing apparatus according to claim 11, wherein the administrator authorizing device authorizes the administrator based on biometric information.

16. The image processing apparatus according to claim 12, wherein the administrator authorizing device authorizes the administrator based on a user ID and a password.

17. The image processing apparatus according to claim 12, wherein the administrator authorizing device authorizes the administrator based on an IC card.

18. The image processing apparatus according to claim 12, wherein the administrator authorizing device authorizes the administrator based on biometric information.

19. An image processing method, comprising:
obtaining image data of an original image;
extracting at least one background dot pattern embedded in a background image included in the image data of the original image;
detecting a match between the at least one background dot pattern and a copy-inhibited background dot pattern while comparing the at least one background dot pattern with the copy-inhibited background dot pattern;
inhibiting an output of the image data when the match between the at least one background dot pattern and the copy-inhibited background dot pattern is detected; and
canceling the inhibition of the output of the image data when the cancellation of the inhibition of the output of the image data is received.

20. The image processing method according to claim 19 further comprising:
setting initial parameters with respect to a detection of a copy-inhibited document;
notifying an inhibition of the output of the image data when the match between the at least one background dot pattern and the copy-inhibited background dot pattern is detected; and
receiving cancellation of the inhibition of the output of the image data.

21. The image processing method according to claim 19, further comprising displaying an image with respect to the image data inhibited from being output.

22. The image processing method according to claim 19, further comprising displaying a log including internal information of an image processing apparatus and external information input to the image processing apparatus.

23. The image processing method according to claim 19, wherein the canceling comprises resetting an image processing apparatus.

24. The image processing method according to claim 19 further comprising authorizing an administrator of an image processing apparatus based on a user ID and a password.

25. The image processing method according to claim 19 further comprising authorizing an administrator of an image processing apparatus based on an IC card.

26. The image processing method according to claim 19 further comprising authorizing an administrator of an image processing apparatus based on biometric information.

27. A computer program product stored on a computer readable storage medium for, when run on an image processing apparatus, carrying out an image processing method, said method comprising:
obtaining image data of an original image;
extracting at least one background dot pattern embedded in a background image included in the image data of the original image;
detecting a match between the at least one background dot pattern and a copy-inhibited background dot pattern while comparing the at least one background dot pattern with the copy-inhibited background dot pattern;
inhibiting an output of the image data when the match between the at least one background dot pattern and the copy-inhibited background dot pattern is detected; and
canceling the inhibition of the output of the image data when the cancellation of the inhibition of the output of the image data is received.

28. The computer program product according to claim 27 further comprising:
setting initial parameters with respect to a detection of a copy-inhibited document;
notifying an inhibition of the output of the image data when the match between the at least one background dot pattern and the copy-inhibited background dot pattern is detected; and
receiving cancellation of the inhibition of the output of the image data.

29. The computer program product according to claim 27, wherein the method further comprises displaying an image with respect to the image data inhibited from being output.

30. The computer program product according to claim 27, wherein the method further comprises displaying a log including internal information of an image processing apparatus and external information input to the image processing apparatus.

31. The computer program product according to claim 27, wherein the act of canceling comprises resetting an image processing apparatus.

32. The computer program product according to claim 27, wherein the method further comprises authorizing an administrator of an image processing apparatus based on a user ID and a password.

33. The computer program product according to claim 27, wherein the method further comprises authorizing an administrator of an image processing apparatus based on an IC card.

34. The computer program product according to claim 27, wherein the method further comprises authorizing an administrator of an image processing apparatus based on biometrics information.

35. A computer readable medium storing computer instructions for performing an image processing method, said method comprising:
obtaining image data of an original image;
extracting at least one background dot pattern embedded in a background image included in the image data of the original image;
detecting a match between the at least one background dot pattern and a copy-inhibited background dot pattern while comparing the at least one background dot pattern with the copy-inhibited background dot pattern;
inhibiting an output of the image data when the match between the at least one background dot pattern and the copy-inhibited background dot pattern is detected; and
canceling the inhibition of the output of the image data when the cancellation of the inhibition of the output of the image data is received.

36. The computer readable medium according to claim 35 further comprising:
setting initial parameters with respect to a detection of a copy-inhibited document;
notifying an inhibition of the output of the image data when the match between the at least one background dot pattern and the copy-inhibited background dot pattern is detected; and
receiving cancellation of the inhibition of the output of the image data.

37. The computer readable medium according to claim 35, wherein said method further comprises displaying an image with respect to the image data inhibited from being output.

38. The computer readable medium according to claim 35, wherein said method further comprises displaying a log including internal information of an image processing apparatus and external information input to the image processing apparatus.

39. The computer readable medium according to claim 35 wherein the act of canceling comprises resetting an image processing apparatus.

40. The computer readable medium according to claim 35, wherein said method further comprises authorizing an administrator of an image processing apparatus based on a user ID and a password.

41. The computer readable medium according to claim 35, wherein said method further comprises authorizing an administrator of an image processing apparatus based on an IC card.

42. The computer readable medium according to claim 35, wherein said method further comprises authorizing an administrator of an image processing apparatus based on biometric information.

43. An image processing apparatus, comprising:
image obtaining means for obtaining image data of an original image;
image output means for outputting the image data obtained by the image obtaining means;
background dot pattern extracting means for extracting at least one background dot pattern embedded in a background image included in the image data of the original image;
copy-inhibited background dot pattern storing means for storing a copy-inhibited background dot pattern;
pattern match detecting means for comparing the at least one background dot pattern extracted by the background dot pattern extracting means with the copy-inhibited background dot pattern stored in the copy-inhibited background dot pattern storing means and for detecting a match between the at least one background dot pattern and the copy-inhibited background dot pattern;
image output inhibiting means for inhibiting an output of the image data by the image output means when the pattern match detecting means detects the match between the at least one background dot pattern and the copy-inhibited background dot pattern; and
canceling means for canceling the inhibition of the output of the image data when the cancellation receiving means receives the cancellation of the inhibition of the output of the image data.

44. The image processing apparatus according to claim 43 further comprising:
initial parameter setting means for setting initial parameters with respect to a detection of a copy-inhibited document before obtaining the image data;
image-output-inhibition notifying means for notifying an inhibition of the output of the image data when the pattern match detecting means detects the match between the at least one background dot pattern and the copy-inhibited background dot pattern; and
cancellation receiving means for receiving cancellation of the inhibition of the output of the image data.

45. The image processing apparatus according to claim 43, wherein the image obtaining means comprises at least one of original image reading means for reading an original image and image receiving means for receiving image data from an external device via a communication line.

46. The image processing apparatus according to claim 43, wherein the image output means comprises at least one of print means for printing the image data obtained by the image obtaining means and image sending means for sending the image data obtained by the image obtaining means to an external device via a communication line.

47. The image processing apparatus according to claim 44, wherein the image-output-inhibition notifying means has at least one of a displaying function and an audio output function.

48. The image processing apparatus according to claim 44, wherein the cancellation receiving means comprises an operation/display unit.

49. The image processing apparatus according to claim 43 further comprising copy-inhibited image display means for displaying an image with respect to the image data inhibited from being output by the image output inhibiting means.

50. The image processing apparatus according to claim 43 further comprising log display means for displaying a log including internal information of the image processing apparatus and external information input to the image processing apparatus.

51. The image processing apparatus according to claim 43, wherein the canceling means has a function of resetting the image processing apparatus, and when the image processing apparatus is reset by the canceling means, the image output means becomes ready for outputting the image data of the original image.

52. The image processing apparatus according to claim 43 further comprising administrator authorizing means for authorizing an administrator of the image processing apparatus.

53. The image processing apparatus according to claim 52, wherein the administrator authorizing means authorizes the administrator when the administrator sets an initial parameter to an initial parameter setting means.

54. The image processing apparatus according to claim 52, wherein the administrator authorizing means authorizes the administrator when a cancellation receiving means receives a request to cancel the inhibition of the output of the image data from the administrator.

55. The image processing apparatus according to claim 53, wherein the administrator authorizing means authorizes the administrator based on a user ID and a password.

56. The image processing apparatus according to claim 53, wherein the administrator authorizing means authorizes the administrator based on an IC card.

57. The image processing apparatus according to claim 53, wherein the administrator authorizing means authorizes the administrator based on biometric information.

58. The image processing apparatus according to claim 54, wherein the administrator authorizing means authorizes the administrator based on a user ID and a password.

59. The image processing apparatus according to claim 54, wherein the administrator authorizing means authorizes the administrator based on an IC card.

60. The image processing apparatus according to claim 54, wherein the administrator authorizing means authorizes the administrator based on biometric information.
